(19) United States
(12) Patent Application Publication
(10) Pub. No.: US 2017/0244741 A1
(43) Pub. Date: Aug. 24, 2017

(54) Malware Identification Using Qualitative Data

(71) Applicant: Microsoft Technology Licensing, LLC, Redmond, WA (US)

(72) Inventors: Methusela Cebrian Ferrer, Melbourne (AU); Dolcita M. Montemayor, Melbourne (AU); Gilda Cruz Lodahl, Redmond, WA (US); Barry R. Golden, Marysville, WA (US)

(21) Appl. No.: 15/047,946

(22) Filed: Feb. 19, 2016

(51) Int. Cl. H04L 29/06; G06Q 50/00

(52) U.S. Cl. CPC H04L 63/1433; H04L 63/145; G06Q 50/01

(57) ABSTRACT

A system analyzes various qualitative data to identify security threats to computing devices. Qualitative data refers to data that may describe a security threat, such as user sentiment or intent data, user online comments, discussions on Web sites, offers for sale on electronic commerce (e-commerce) Web sites, blogs, news articles, and so forth. The qualitative data is analyzed, and data that is classified by the system as indicating malware is identified and acted upon (e.g., notifications provided to the appropriate users and/or devices). The use of qualitative data allows the system to be proactive in protecting against security threats. By analyzing the qualitative data, expected or future security threats to computing devices can be identified and mitigated (possibly even prevented) before any computing devices are attacked.

### BACKGROUND

Computing devices have become increasingly commonplace in our lives, and with this, have become increasingly interconnected. Many of our devices can communicate with numerous other devices via the Internet and/or other data networks. While this increased connectivity has many benefits, it is not without its problems. One such problem is that our devices have become accessible to attack by malicious users or programs that attempt to steal data or information, take over operation of our devices, and so forth. Protecting against such attacks, however, continues to be difficult.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, input data is obtained from multiple qualitative data sources. Text included in the input data is identified, and the identified text is classified, using a classifier, as either indicating malware or not indicating malware. For identified text classified as indicating malware, an indication that the identified text is classified as indicating malware is communicated to an output module, and a notification of the identified text is communicated to one or more recipient devices.

In accordance with one or more aspects, a system includes an input data collection module configured to obtain multiple pieces of input data each from one of multiple qualitative data sources, and an input data processing module configured to extract text from each piece of input data. The system further includes a qualitative data analysis module implementing a classifier configured to classify, for each piece of input data, the piece of input data as malware in response to the extracted text having characteristics of malware, and an output module configured to send a notification identifying the piece of input data as malware.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example system implementing the malware identification using qualitative data in accordance with one or more embodiments.

FIG. 2 illustrates an example qualitative data based malware identification system in accordance with one or more embodiments.

FIG. 3 is a flowchart illustrating an example process for implementing the malware identification using qualitative data in accordance with one or more embodiments.

FIG. 4 illustrates an example of the use of the techniques discussed herein, in which a malicious user creates malware and attempts to sell the malware on an e-commerce service.

FIG. 5 illustrates an example system that includes an example computing device that is representative of one or more systems and/or devices that may implement the various techniques described herein.

### DETAILED DESCRIPTION

Malware identification using qualitative data is discussed herein. A qualitative data based malware identification system operates as an integrated early threat warning signal framework, empowering users to leverage the information from the system in their malware protection systems (e.g., their anti-virus or other anti-malware programs). The qualitative data based malware identification system analyzes various qualitative data and optionally quantitative data to identify malware, which can be a security threat to computing devices. Malware refers to a malicious program that accesses or uses a computing device in a manner contrary to and/or without regard for the device user's (or owner's) desires. Malware can, for example, steal information from the computing device, use the computing device to attack other computing devices, use the computing device to encrypt the user's data to be held for ransom, and so forth. Malware can also be any program that poses a threat or advanced persistent threat to the computing device, a potentially unwanted application (PUA) or other unwanted software, and so forth. Once a security threat is identified, various actions can be taken to protect or guard against the security threat. These actions can include notifying system administrators or users what to look for to block the security threat, updating anti-malware programs on devices to identify and block the security threat, and so forth.

The qualitative data based malware identification system operates based at least in part on analyzing qualitative data. Qualitative data refers to data that may describe a security threat, and can be obtained from any of various text sources (whether structured text or unstructured text). Qualitative data can be, for example, user sentiment analysis or intent data (e.g., data describing a user's feelings, attitude, intent, and so forth regarding particular products or programs, anticipated products or programs, and so forth), user online comments, descriptions of items for sale, descriptions of items being designed or planned, descriptions of locations (e.g., network addresses) accessed or patterns of location accesses, descriptions of search queries, and so forth. For example, qualitative data can be discussions on Web sites, offers for sale on electronic commerce (e-commerce) Web sites, blogs, news articles, and so forth. The qualitative data is analyzed, and data that is classified by the qualitative data based malware identification system as malware is identified and acted upon (e.g., notifications provided to the appropriate users and/or devices).

The qualitative data based malware identification system optionally also operates based on analyzing quantitative data. Quantitative data refers to data indicating detected security threats, and reflects encountered security threats (as opposed to qualitative data which is text describing security threats). Quantitative data can be data indicating devices used during security threat encounters, a frequency with which known security threats are reported or identified as encountered by devices, locations of encountered security threats, and so forth. This quantitative data can also be analyzed and acted upon (e.g., notifications provided to the appropriate user and/or devices).

The techniques discussed herein allow security threats to computing devices to be identified based on a variety of different information available over a network (e.g., the Internet). A wholistic approach is provided, supporting the use of both qualitative data and quantitative data in identifying security threats. This identification of security threats allows users and devices to make informed decisions on how to better protect their systems or enterprise software security infrastructure against such threats, thereby increasing the security of users' devices. Additionally, the use of qualitative data allows the system to be proactive in protecting against security threats. By analyzing the qualitative data, expected or future security threats to computing devices can be identified and mitigated (possibly even prevented) before any computing devices are attacked.

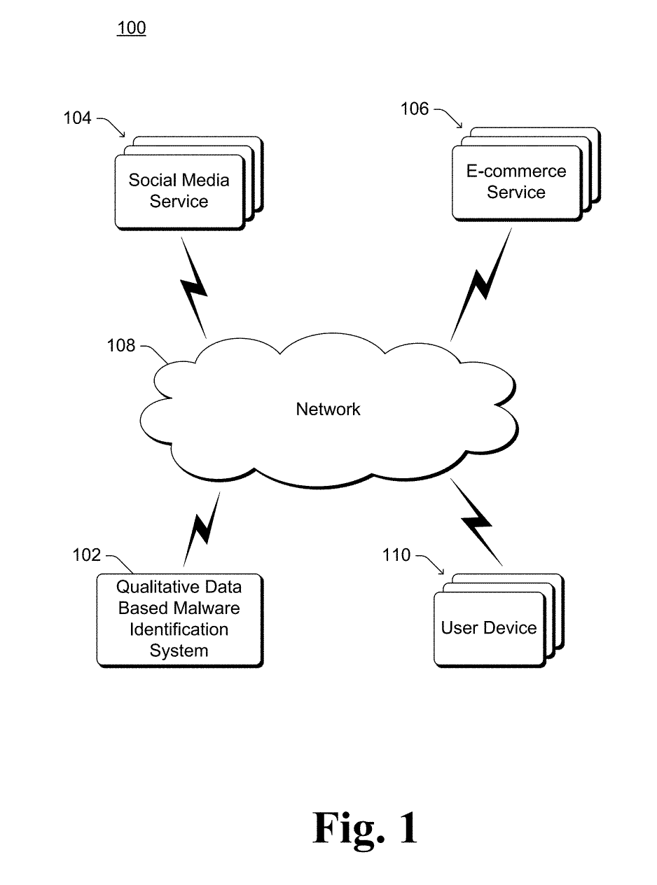

FIG. 1 illustrates an example system 100 implementing the malware identification using qualitative data in accordance with one or more embodiments. System 100 includes a qualitative data based malware identification system 102 that can communicate with one or more social media services 104 and/or one or more e-commerce services 106 via a network 108. The network 108 can be a variety of different networks, including the Internet, a local area network (LAN), a public telephone network, an intranet, other public and/or proprietary networks, combinations thereof, and so forth.

The qualitative data based malware identification system 102 can be implemented using one or more of a variety of different types of devices. For example, the qualitative data based malware identification system 102 can be implemented using one or more server computers, desktop computers, laptop or netbook computers, mobile devices, and so forth. Similarly, each social media service 104 and each e-commerce service 106 can be implemented using one or more of a variety of different types of devices analogous to the qualitative data based malware identification system 102.

Each social media service 104 is a service that provides online content to users of the network 108. A social media service 104 can provide online content in any of a variety of different manners. Some social media services 104 may be subscription services in which an account is set up by a user to log into the service 104, and other services 104 can be accessed openly without any account or subscription. Examples of social media services 104 include social networking services, news services, blogging services, message forum services, and so forth. It should be noted that social media services 104 can include content provided by the owners or administrators of the services 104, and/or content provided by users of the services 104. For example, a service 104 may provide a forum space where users can post messages to one another, a service 104 may provide articles that users can post comments for, and so forth.

Each e-commerce service 106 is a service that facilitates electronic commerce among users of the network 108. An e-commerce service 108 can be, for example, an electronic advertising system in which items for sale can be advertised, an electronic exchange system in which electronic content (e.g., computer programs) can be bought and sold, and so forth.

One or more user devices 110 can also communicate with the qualitative data based malware identification system 102, the social media services 104, and/or the e-commerce service 106 via the network 108. Each user device 110 can be a variety of different types of devices, such as a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, each user device 110 may range from a full resource computing device with substantial memory and processor resources (e.g., personal computers, game consoles) to a low-resource device with limited memory and/or processing resources (e.g., traditional set-top boxes, hand-held game consoles).

Each user device 110 can face security threats from various different malware sources via the network 108. These security threats are discussed herein as coming from malware. Attempts to install malware on a user device 110 (also referred to as infecting a user device 110 with malware) can come from many different sources, such as a social media service 104, an e-commerce service 106, a component of the network 108, another user device 110, and so forth. It should be noted that the source of malware need not be (and oftentimes is not) the source of qualitative data. The qualitative data source identifies the existence of the malware, but the attack on a computing device is typically from a different device. For example, a social media service 104 may include qualitative data describing the malware, but an attack on a particular user device 110 using that malware can come from another user device 110.

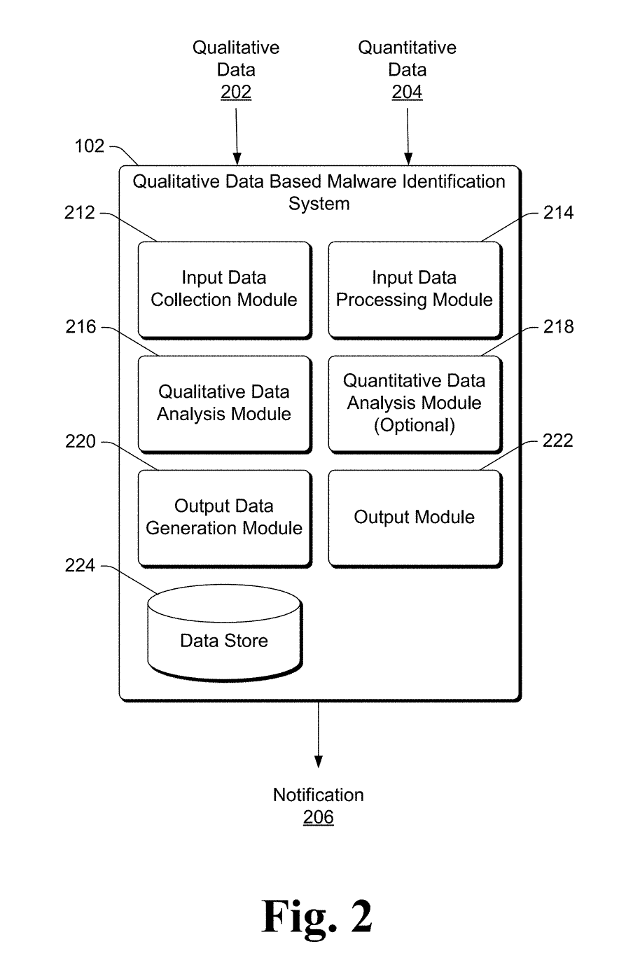

FIG. 2 illustrates an example qualitative data based malware identification system 102 in accordance with one or more embodiments. The qualitative data based malware identification system 102 obtains qualitative data 202 and optionally quantitative data 204. The qualitative data 202, as discussed above, refers to data that may describes a security threat. The quantitative data 204, as discussed above, refers to data indicating detected security threats. The qualitative data based malware identification system 102 analyzes the qualitative data 202, as well as optionally the quantitative data 204, and generates one or more notifications 206. The notifications can be in the form of messages (e.g., email messages, text messages, multimedia messages) provided to individuals such as a user or administrator, messages or descriptions (e.g., software or code updates) provided to anti-malware programs, and so forth.

The qualitative data based malware identification system 102 includes an input data collection module 212, an input data processing module 214, a qualitative data analysis module 216, an optional quantitative data analysis module 218, an output data generation module 220, and an output module 222. The qualitative data based malware identification system 102 also includes a data store 224.

The input data collection module 212 obtains data from various different qualitative data sources. A qualitative data source is a source of qualitative data, such as one or more social media services 104 of FIG. 1, one or more e-commerce services 106 of FIG. 1, and so forth. The data can be obtained in any of a variety of different manners, such as sending a request for and receiving the data (e.g., requesting and receiving a HyperText Markup Language (HTML) document or Web page). In one or more embodiments, each social media service 104 and each e-commerce service 106 hosts one or more Web pages that are displayed, and the input data collection module 212 obtains data from a service 104 or 106 by obtaining the one or more Web pages that service displays (e.g., obtaining a copy of the HTML page via a HyperText Transfer Protocol (HTTP) request).

Additionally or alternatively, the data can be obtained in various other manners. In one or more embodiments, the input data collection module 212 accesses a qualitative data source and obtains data that can be displayed on a screen or other display device. This data can be an HTML document, or alternatively can be in any of a variety of other forms (e.g., an image such as a Graphics Interchange Format (GIF) file or a Joint Photographic Experts Group (JPEG) file, a word processing document or other text file, and so forth). A screen capture of this returned data is captured or otherwise obtained by the input data collection module 212, such as by displaying the returned data on a display device (or writing the data to a display buffer even though no display device may be in use by the qualitative data based malware identification system) and performing a screen capture of the displayed data (e.g., copying the contents of the display buffer, intercepting an output of the display buffer, using a separate imaging device (e.g., a camera) to capture the data displayed on the display device), and so forth).

In one or more embodiments, the data received from a qualitative data source is obtained or processed in different pieces. A piece of qualitative data refers to a portion of the input data obtained by the input data collection module 212 that is processed by the qualitative data based malware identification system 102. For example, an HTML document can be a piece of qualitative data, a Web page can be a piece of qualitative data, a screen capture image can be a piece of qualitative data, and so forth.

A wide range of various different types of qualitative data sources exists. In one or more embodiments, the qualitative data sources include sources to which users (e.g., via the user devices 110 of FIG. 1) can submit samples of suspected malware and/or additional information regarding suspected malware. Such sources can include malware submission services or Web sites, email accounts or addresses, message boards or forums, and so forth. These submitted samples of suspected malware and/or additional information regarding suspected malware can be qualitative data obtained by the input data collection module 212.

Additionally or alternatively, the qualitative data sources include reputation systems that verify the reputation or trustworthiness of various online content sources. Records displayed or otherwise maintained by a reputation system can be qualitative data obtained by the input data collection module 212.

Additionally or alternatively, the qualitative data sources include search engines, such as Internet search engines. Search queries or other information regarding searches that is maintained or displayed by the search engines can be qualitative data obtained by the input data collection module 212.

Additionally or alternatively, the qualitative data sources include news reporting services. Articles, letters written to the news reporting services, comments posted to the news reporting services, and so forth can be qualitative data obtained by the input data collection module 212.

Additionally or alternatively, the qualitative data sources include security threat behavior replication services that attempt to replicate or duplicate security threats. Data displayed, maintained, or otherwise collected by these security threat behavior replication services can be qualitative data obtained by the input data collection module 212.

Additionally or alternatively, the qualitative data sources include communication services or applications, such as instant messaging platforms. Data displayed, maintained, or otherwise collected by these communication services or applications can be qualitative data obtained by the input data collection module 212.

Additionally or alternatively, the qualitative data sources include social media services or applications. Data displayed, maintained, or otherwise collected by these social media services or applications can be qualitative data obtained by the input data collection module 212.

Additionally or alternatively, the qualitative data sources include gaming services or applications. These gaming service or applications can support online gaming, can be forums or message boards where other (e.g., non-online) games can be discussed, and so forth. Data displayed, maintained, or otherwise collected by these gaming services or applications can be qualitative data obtained by the input data collection module 212.

Additionally or alternatively, the qualitative data sources include domain name system (DNS) services, such as DNS servers. DNS services assign names to network addresses (e.g., Internet protocol (IP) addresses) and facilitate communication among devices over a network (e.g., the network 108 of FIG. 1). DNS services can maintain or collect various information regarding accesses to the DNS service, attempted abuse of or attacks against the DNS service, and so forth. Data maintained or otherwise collected by these DNS services can be qualitative data obtained by the input data collection module 212.

Additionally or alternatively, the qualitative data sources include various social media services or e-commerce services that describe malware, offer malware for sale, and so forth. Such social media services or e-commerce services may also be referred to as the “darknet”. Data displayed, maintained, or otherwise collected by these social media services or e-commerce services can be qualitative data obtained by the input data collection module 212.

Additionally or alternatively, the qualitative data sources include the user devices themselves (e.g., the user devices 110 of FIG. 1) and/or components of the network (e.g., the network 108 of FIG. 1). Various devices or network components can have installed modules (e.g., software, firmware, and/or hardware) to monitor data flowing through those devices or network components. This monitored data can obtained by the input data collection module 212. In one or more embodiments, this monitored data is obtained by the input data collection module 212 in an anonymous manner so that the input data collection module 212 does not receive (or maintain) an indication of which device or network component the data was obtained from. This data obtained from such devices or network components can be qualitative data obtained by the input data collection module 212.

The input data processing module 214 processes the input data obtained by the input data collection module 212 and identifies or extracts text from the input data. Different pieces of input data can be obtained as discussed above, and the input data processing module 214 analyzes these pieces of input data to identify or extract text from the input data. In one or more embodiments, the input data processing module 214 analyzes the pieces of data individually. Additionally or alternatively, the input data processing module 214 can analyze pieces of data collectively as a group. The manner in which the input data processing module 214 analyzes the input data can vary based on the source of the input data.

In one or more embodiments, input data obtained by the input data collection module 212 is added to an input buffer, which can be a database or other data store. The input data is maintained temporarily in the input buffer until the input data is analyzed by the input data processing module 214. After being analyzed the input data is removed from the input buffer, making room for new input data (from the same or a different source). The input buffer can be, for example, at least part of the data store 224.

In one or more embodiments, the input data processing module 214 analyzes the input data by performing natural language processing (NLP) analysis on the input data. Any of a variety of public and/or proprietary natural language processing techniques can be used, for example techniques to summarize the input data (in which case the summary is the identified or extracted text). By way of another example, techniques to extract key words from the input data, which refer to words that are deemed to be of the most relevance in identifying malware, can also be used (in which case the extracted key words are the identified or extracted text).

Additionally or alternatively, the input data processing module 214 analyzes the input data by identifying portions of the input data that include text that is displayed when the input data is displayed, a process also referred to as scraping the input data. For example, an obtained HTML Web page can be scraped to identify the words that are displayed when the Web page is displayed.

Additionally or alternatively, the input data processing module 214 analyzes the input data by translating the input data into one or more different languages. For example, the obtained input data may be in French, and the input data processing module 214 translates the obtained input data into English.

Additionally or alternatively, the input data processing module 214 analyzes the input data by identifying text in the input data by performing optical character recognition. Any of a variety of different public and/or proprietary optical character recognition techniques can be used. For example, the data in a GIF or JPEG file can be analyzed to recognize text in the file.

The input data processing module 214 provides the text that it identifies or extracts to the qualitative data analysis module 216. This text can be provided to the qualitative data analysis module 216 in different manners, such as by storing the text in a known location (e.g., of the data store 224), providing the text as parameters of function or interface calls, and so forth.

In one or more embodiments, the input data processing module 214 also maintains an association between the input data and the text identified or extracted from the input data. For example, an association or correspondence between each piece of input data and the text identified or extracted from that piece of input data can be maintained. This allows other modules in the qualitative data based malware identification system 102 (e.g., the qualitative data analysis module 216, the output module 222, etc.) to know which piece of input data is associated with which identified or extracted text. This association or correspondence can be maintained in a variety of different manners. For example, the piece of input data can be provided to the qualitative data analysis module 216 along with the identified or extracted text. By way of another example, an identifier can be assigned to each piece of input data (e.g., by the input data collection module 212 or the input data processing module 214) that allows the qualitative data based malware identification system 102 to distinguish that piece of input data from other pieces of input data. For text that is identified or extracted from one or more pieces of input data, the input data processing module 214 can associate the identifier of each of those one or more pieces of input data with the identified or extracted text, and provide the associated identifier(s) to the qualitative data analysis module 216.

The qualitative data analysis module 216 classifies the text provided by the input data processing module 214 using various different characteristics of the text. These characteristics can vary, and the characteristics that are used can be selected by the qualitative data analysis module 216 using training as discussed in more detail below. These characteristics can include, for example, the number of words included in the text, which specific words are included in the text, a frequency with which particular words are included in the text, and so forth.

In one or more embodiments, the qualitative data analysis module 216 includes a binary classifier that classifies the text provided by the input data processing module 214 as either indicating malware or not indicating malware. Alternatively, the qualitative data analysis module 216 can include a classifier that classifies the text provided by the input data processing module 214 as one of any number of levels of malware threats. For example, the classifier may classify the text as one of ten different levels (e.g., numeric values 1 through 10) with lower levels (e.g., smaller numeric values) indicating less of a risk of the text indicating malware than higher levels (e.g., larger numeric values). By way of another example, the classifier may classify the text as one of three different levels each of which indicates a risk of the text indicating malware (e.g., low, medium, and high levels).

In one or more embodiments, the qualitative data analysis module 216 implements a natural machine learning language classifier that is trained on a set of input text. This training is performed by providing training data to the classifier module that includes text that is known to indicate malware and text that is known to not indicate malware. The classifier uses this training data to automatically configure itself to classify text input. Any of a variety of public and/or proprietary techniques can be used to train the classifier, and the specific manner in which the classifier is trained can vary based on the particular manner in which the classifier is implemented.

The classifier can be implemented as any of a variety of different types of natural machine learning language classifiers. In one or more embodiments, the classifier is implemented as a deep neural network. A deep neural network is an artificial neural network that includes an input layer and an output layer. The input layer receives the text provided by the input data processing module 214 as an input, the output layer provides an indication of whether the text indicates malware, and multiple hidden layers between the input layer and the output layer perform various analysis on the input text to generate indication of whether the text indicates malware.

The classifier can alternatively be implemented as any of a variety of other types of classifiers. For example, the classifier can be implemented using any of a variety of different clustering algorithms, any of a variety of regression algorithms, any of a variety of sequence labeling algorithms, and so forth. By way of another example, the classifier may apply any of a variety of different rules or criteria to the input text provided by the input data processing module 214 to determine whether the input text indicates malware. By way of another example, the classifier may be implemented using Bayesian optimization, Markov logic networks, hidden Markov models, restricted Boltzmann machines, and so forth.

The qualitative data analysis module 216 provides the indication of whether the text input to the qualitative data analysis module 216 indicates malware to the output data generation module 220. This indication can be provided to the output data generation module 220 in different manners, such as by storing the text in a known location (e.g., of the data store 224), providing the text as parameters of function or interface calls, and so forth. An indication of the associated piece of input data can also be provided to the output data generation module 220. This indication can take various forms and be provided in different manners analogous to the discussion above, such as by providing the piece of input data itself, providing an identifier of the piece of input data, and so forth. An indication of the input data provided to the qualitative data analysis module 216 by the input data processing module 214 and on which the indication was generated can also be provided in different manners analogous to the discussion above, such as by providing the input data itself, providing an identifier of the input data, and so forth.

In one or more embodiments in which the qualitative data analysis module 216 implements a binary classifier, only indications of text that indicate malware are provided to the output data generation module 220. Text that does not indicate malware can be deleted or otherwise ignored by the qualitative data based malware identification system 102. Similarly, pieces of input data from which text that does not indicate malware is identified or extracted can be deleted or otherwise ignored by the qualitative data based malware identification system 102.

It should be noted that, as discussed above, the qualitative data based malware identification system 102 can be implemented using multiple computing devices. This allows, for example, the qualitative data analysis module 216 to be implemented across any number of computing devices, allowing quicker indications of whether input data indicates malware than may be provided by a single computing device. For example, if a new source of qualitative data is accessed by the input data collection module 212 resulting in a large amount of input data being obtained by the input data collection module 212 at once, the analysis of the text identified in or extracted from this input data can be performed across many different computing devices, allowing the input data to be quickly analyzed.

In one or more embodiments, the classifier implemented by the qualitative data analysis module 216 is re-trained over time. For example, text that is classified as not indicating malware (and optionally confirmed by another component, user, administrator, etc. as not indicating malware) can be collected and used to recursively re-train the classifier.

Additionally or alternatively, the qualitative data analysis module 216 can run multiple different classifiers concurrently and compare the results of those classifiers. In one or more embodiments, if at least one classifier classifies the text as indicating malware then the qualitative data analysis module 216 provides an indication to the output data generation module 220 that the text indicates malware. Alternatively, the classification generated by one classifier (a current classifier) can be provided as the output of the qualitative data analysis module 216, and if one or more other classifiers provides a more accurate output, then the current classifier is changed to be the classifier providing the more accurate output. Whether another classifier provides a more accurate output and thus the current classifier is changed can be determined in different manners. For example, the current classifier can be changed to a different classifier that classifies input text as indicating malware at a rate at least a threshold amount greater than the current classifier, the current classifier can be changed to a different classifier that classifies at least a threshold number of input texts as indicating malware that the current classifier did not classify as indicating malware, and so forth. These outputs of the classifiers can optionally be verified by a user or administrator before changing the current classifier. For example, if an additional classifier is determined to provide a more accurate output, an indication of this additional classifier (e.g., the text (and/or associated pieces of input data) that the additional classifier classified as indicating malware that the current classifier did not classify as indicating malware) can be provided to a user or administrator of the qualitative data based malware identification system 102, and this user or administrator can verify whether the additional classifier is actually more accurate and thus whether to change the current classifier to be the additional classifier.

Thus, this use of multiple classifiers can be used as a self-evaluation, allowing the appropriate classifier to use at different times to be changed. This allows the qualitative data analysis module 216 to adapt to changes in types of malware or security threats, changes to the way in which malware or security threats are referred to in qualitative data sources, and so forth.

The output data generation module 220 performs various analysis of the indications generated by the qualitative data analysis module 216. This analysis can be based on the indications and/or the text (provided to the qualitative data analysis module 216 by the input data processing module 214) on which the indication was based. The output data generation module 220 can include various processing and/or modeling of the indications generated by the qualitative data analysis module 216. In one or more embodiments, the indications generated by the output data generation module 220 are added to an output buffer, which can be a database or other data store. The indications are maintained temporarily in the output buffer until the indications are analyzed by the output data generation module 220. After being analyzed the indication is removed from the output buffer, making room for new indications. The indications can optionally be stored in a database or other data store, allowing longer term access to and analysis of the indications (e.g., to allow modeling or analysis over an extended amount of time, such as days or weeks). The output buffer can be, for example, at least part of the data store 224.

In one or more embodiments, the output data generation module 220 analyzes the indications by performing natural language processing referred to as natural language synthesis on the indications. Any of a variety of public and/or proprietary natural language synthesis techniques can be used to translate the indications and/or text into data that can be output by the qualitative data based malware identification system 102. For example, the text can be converted to natural language sentences or natural language lists, making the text more readable for users or administrators that receive notifications from the qualitative data based malware identification system 102.

In one or more embodiments, the output data generation module 220 analyzes the indications and/or text using geographic information system modeling. Geographic information system modeling refers to geographic modeling systems that, given geographic locations with which indications of malware are associated, model the spread of the malware across various geographic regions (e.g., states, countries, the world).

A geographic location can be associated with an indication of malware in various manners. In one or more embodiments, the text obtained from the qualitative data source and on which the indication of malware was based includes an indication of the geographic location (e.g., a city name, state name, network address (e.g., IP address) associated with a particular geographic region such as a city, and so forth). Additionally or alternatively, the qualitative data source can provide an indication of the geographic location from which particular input data was obtained (such as the network address (e.g., IP address) of a user that posts a comment on a social media service).

In one or more embodiments, the output data generation module 220 analyzes the indications and/or text using network threat modeling. Network threat modeling is similar to geographic information system modeling, but accounts for network topology across a geographic region (e.g., states, countries, the world). For example, rather than spreading like a biological virus would spread across a geographic region, the spread of malware may be affected by available networks, data transfer speeds, and so forth (e.g., malware may spread from a data center outward to smaller data repositories or networks). Network threat modeling can model the spread of the malware across various geographic regions while taking into account network topology in the region.

The output data generation module 220 generates an output description of indications of malware, and provides that output description to the output module 222. This output description can be provided to the output module 222 in different manners, such as by storing the output description in a known location (e.g., of the data store 224), providing the output description as parameters of function or interface calls, and so forth. The output description includes the various data generated by the output data generation module 220, such as natural language synthesized text describing the indication and/or text on which the indication was based, predictions of the spread of malware given various modeling performed by the output data generation module 220, and so forth. The output description can also optionally include the piece of input data from which the indication was generated.

The output module provides of notifications of malware to various individuals, groups of individuals, machines, and so forth. These notifications include the output description generated by the output data generation module 220. The notifications can be in the form of messages (e.g., email messages, text messages, multimedia messages) provided to individuals such as a user or administrator, messages or descriptions (e.g., software or code updates) provided to anti-malware programs, and so forth.

The notifications can be communicated to various different individuals, such as administrators of the qualitative data based malware identification system 102, partners of the owner of the qualitative data based malware identification system 102, subscribers to a service provided by the qualitative data based malware identification system 102, and so forth. For example, the messages can be part of an alert or notification feed that is provided by the qualitative data based malware identification system 102 to various individuals.

The qualitative data based malware identification system 102 also optionally includes a quantitative data analysis module 218. The quantitative data analysis module 218 obtains quantitative data from various different quantitative data sources. A quantitative data source is a source of quantitative data, such as services or devices that maintain information regarding device usage, security threat encounters, and so forth. For example, anti-virus or other anti-malware programs on user devices 110 of FIG. 1 can notify various different services or devices when malware is encountered, and provide various information such as the geographic region of the device, an identification of the malware encountered, and so forth. By way of another example, users of the user devices 110 can cause programs to notify different services or devices of malware, such as selecting a “give me more details” link when possible malware is reported to the individuals.

The quantitative data analysis module 218 analyzes the obtained quantitative data and generates a quantitative data description regarding malware. This quantitative data description can include, for example, an indication of the most frequently encountered malware over some time duration (e.g., the previous 24 hours), an indication of geographic locations where particular malware is being encountered, and so forth. Encountering malware refers to malware infecting or attempting to infect a device.

Various different analysis can be performed on quantitative data. For example, the quantitative data analysis module 218 can apply geographic information system modeling, network threat modeling, and so forth to quantitative data analogous to the application of such modeling by the qualitative data analysis module 216. For example, geographic locations (and optionally network topology) can be used to model the spread of malware across various geographic regions given the locations of malware obtained as part of the quantitative data.

The quantitative data analysis module 218 provides the quantitative data description that it generates to the output module 222. This quantitative data description can be provided to the output module 222 in different manners, such as by storing the quantitative data description in a known location (e.g., of the data store 224), providing the quantitative data description as parameters of function or interface calls, and so forth. The output module 222 can then notify various individuals or devices of the quantitative data description, analogous to the output description generated by the qualitative data analysis module 216 discussed above.

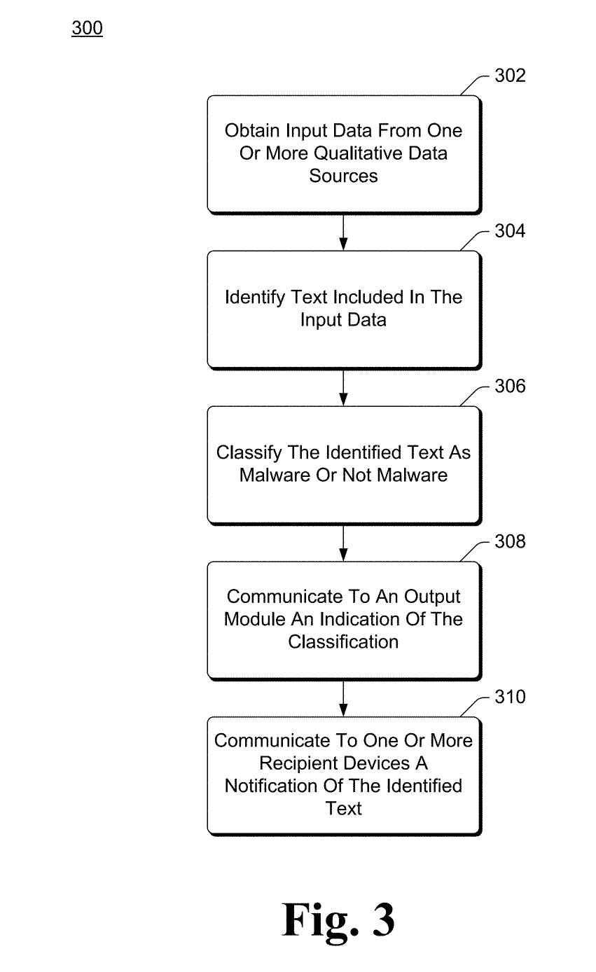

FIG. 3 is a flowchart illustrating an example process 300 for implementing the malware identification using qualitative data in accordance with one or more embodiments. Process 300 is carried out by a system, such as qualitative data based malware identification system 102 of FIG. 1 or FIG. 2, and can be implemented in software, firmware, hardware, or combinations thereof. Process 300 is shown as a set of acts and is not limited to the order shown for performing the operations of the various acts. Process 300 is an example process for implementing the malware identification using qualitative data; additional discussions of implementing the malware identification using qualitative data are included herein with reference to different figures.

In process 300, input data is obtained from one or more qualitative data sources (act 302). These qualitative data sources can be various different sources, such as social media services, e-commerce services, and so forth.

Text included in the input data is identified or otherwise extracted from the input data (act 304). Various different techniques can be used to identify or extract the data, including Web page scraping, language translations, natural language processing, and so forth.

The identified text is classified as indicating malware or not indicating malware (act 306). This classification can be a binary classification, or classification into one of three or more different levels indicating a risk of the identified text indicating malware as discussed above.

An indication of the classification is communicated to an output module (act 308). The indication can be the indication generated by the classifier, the identified text from which the indication generated by the classifier was generated, the input data corresponding to the identified text, additional data generated by analyzing the identified text or the input data, combinations thereof, and so forth.

A notification of the identified text is communicated to one or more recipient devices (act 310). These recipient devices can be various devices used by individuals that are to receive the notifications (e.g., devices of users subscribing to a notification feed that is provided by the qualitative data based malware identification system 102 as discussed above).

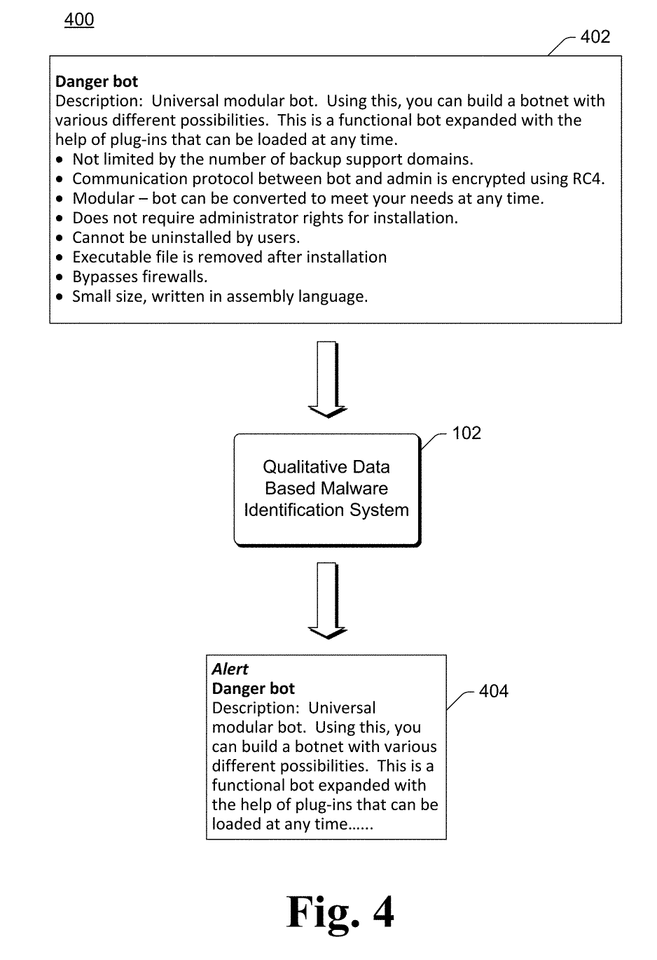

The techniques discussed herein support various different usage scenarios. FIG. 4 illustrates an example 400 of the use of the techniques discussed herein, in which a malicious user creates malware and attempts to sell the malware on an e-commerce service. The user posts a description 402 of the malware. The qualitative data based malware identification system 102 of FIG. 1 or FIG. 2 obtains the description 402, identifies text from the description 402, and classifies the identified text as malware. The qualitative data based malware identification system 102 communicates a notification 404 to various recipient devices that the malware described in the description 402 is likely to be used in the near future to attack devices and to be ready for it. The notification 404 can include the description 402, or alternatively other output descriptions of the malware as discussed above.

Thus, as can be seen in the example of FIG. 4, the qualitative data based malware identification system notifies various individuals or devices of security threats they may be seeing in the future. By analyzing the qualitative data, the techniques discussed herein are able to identify security threats early, and based on data obtained from various social media services or e-commerce services rather than waiting to be notified of an infection by a user or anti-virus program. Thus, it is possible that newly generated malware can be identified and users (e.g., administrators) can react to the identification prior to any machine being infected by the malware. Such reactions can be, for example, to modify their anti-virus or anti-malware programs to detect and block the newly generated malware. These reactions can be done by individual users (e.g., administrators) or automatically by various devices or components (e.g., using the information included in the notification 404 to generate various rules or criteria allowing the newly generated malware to be blocked).

Furthermore, the qualitative data based malware identification system can further analyze quantitative data as discussed above. Notifications can be provided to users and/or devices regarding security threats identified from qualitative data and quantitative data as well. The qualitative data based malware identification system thus provides a wholistic approach to malware identification, relying on both qualitative data and quantitative data.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

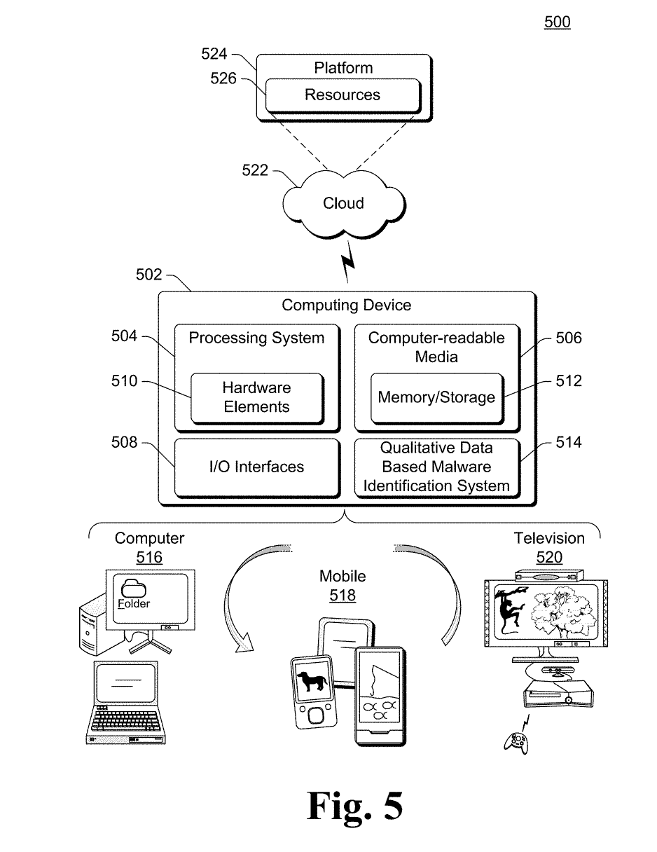

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system. The computing device 502 (and system 500 in general) supports and enables ubiquitous computing technologies, including networking (e.g., the Internet or other data networks) technologies, advanced middleware, operating systems, mobile code, sensors, microprocessors, I/O and user interfaces, mobile protocols, location and positioning technologies, and so forth.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

The computing device 502 also includes a qualitative data based malware identification system 514. The qualitative data based malware identification system 514 provides various classification of text based on qualitative data and notification of potential malware as discussed above. The qualitative data based malware identification system 514 can implement, for example, the qualitative data based malware identification system 102 of FIG. 1 or FIG. 2. It should be noted that the qualitative data based malware identification system 514 in FIG. 5 can be representative of a part of the qualitative data based malware identification system 102 of FIG. 1 or FIG. 2. For example, the computing device 502 can be used to implement at least part of the input data collection module 212, at least part of the input data processing module 214, at least part of the qualitative data analysis module 216, at least part of the quantitative data analysis module 218, at least part of the output data generation module 220, at least part of the output module 222, at least part of the data store 224 of FIG. 2, or combinations thereof.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous computing technologies and environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: obtaining input data from multiple qualitative data sources; identifying text included in the input data; classifying, using a classifier, the identified text as either indicating malware or not indicating malware; communicating to an output module, for identified text classified as indicating malware, an indication that the identified text is classified as malware; and communicating a notification of the identified text to one or more recipient devices.

Alternatively or in addition to any of the above described methods, any one or combination of: the qualitative data comprising data from user sentiment analysis or user online comments; the multiple qualitative data sources including one or more social media services accessed via the Internet; the multiple qualitative data sources including one or more electronic commerce services accessed via the Internet; the identifying text including scraping HTML Web pages to obtain the text; the classifier comprising a classifier trained using training data, and the method further comprising re-training the classifier over time using identified text that is classified as not malware; the method further comprising classifying, using one or more additional classifiers, the identified text as either indicating malware or not indicating malware, determining if one of the one or more additional classifiers more accurately classified the identified text as indicating malware or not indicating malware, and changing to using the additional classifier rather than the classifier to classify the identified as either indicating malware or not indicating malware in response to determining that the additional classifier more accurately classifies the identified text as indicating malware or not indicating malware; the notification of the identified text comprising the input data from which the identified text was identified; the method further comprising receiving quantitative data describing device usage or security threat encounters, generating, based on the quantitative data, a quantitative data description, communicating the quantitative data description to the output module, and communicating a notification of the quantitative data description to the one or more recipient devices.

A system comprising: an input data collection module configured to obtain multiple pieces of input data each from one of multiple qualitative data sources; an input data processing module configured to extract text from each piece of input data; a qualitative data analysis module implementing a classifier configured to classify, for each piece of input data, the piece of input data as malware in response to the extracted text having characteristics of malware; and an output module configured to send a notification identifying the piece of input data as malware.

Alternatively or in addition to any of the above described systems, any one or combination of: the classifier comprising a binary classifier that classifies the extracted text as either indicating malware or not indicating malware; one of the multiple pieces of data comprising an HTML Web page, and the input data processing module being configured to extract text from the HTML Web page by scraping the HTML Web page; the multiple qualitative data sources including one or more social media services accessed via the Internet and one or more electronic commerce services accessed via the Internet; the notification of the identified text comprising the piece of input data from which the identified text was identified.

A system implemented on one or more computing devices, the system including: one or more processors; one or more computer-readable storage medium having stored thereon multiple instructions that, responsive to execution by the one or more processors, cause the one or more processors to perform acts comprising: obtaining multiple pieces of input data from one or more qualitative data sources; identifying text included in each piece of input data; classifying, using a trained classifier, the identified text as either indicating malware or not indicating malware; communicating to an output module, for identified text classified as indicating malware, an indication that the piece of input data from which the text was identified is classified as malware; and communicating a notification of the identified text to one or more recipient devices.

Alternatively or in addition to any of the above described systems, any one or combination of: the one or more qualitative data sources including one or more social media services accessed via the Internet; the one or more qualitative data sources including one or more electronic commerce services accessed via the Internet; the trained classifier comprising a classifier trained using training data, and the acts further comprising re-training the classifier over time using identified text that is classified as not indicating malware; the notification of the identified text comprising the input data from which the identified text was identified; the acts further comprising receiving quantitative data describing device usage or security threat encounters, generating, based on the quantitative data, a quantitative data description, communicating the quantitative data description to the output module, and communicating a notification of the quantitative data description to the one or more recipient devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining input data from multiple qualitative data sources;
identifying text included in the input data;
classifying, using a classifier, the identified text as either indicating malware or not indicating malware;
communicating to an output module, for identified text classified as indicating malware, an indication that the identified text is classified as malware; and
communicating a notification of the identified text to one or more recipient devices.

2. The method as recited in claim 1, the qualitative data comprising data from user sentiment analysis or user online comments.

3. The method as recited in claim 1, the multiple qualitative data sources including one or more social media services accessed via the Internet.

4. The method as recited in claim 1, the multiple qualitative data sources including one or more electronic commerce services accessed via the Internet.

5. The method as recited in claim 1, the identifying text including scraping HTML Web pages to obtain the text.

6. The method as recited in claim 1, the classifier comprising a classifier trained using training data, and the method further comprising re-training the classifier over time using identified text that is classified as not malware.

7. The method as recited in claim 1, further comprising:
classifying, using one or more additional classifiers, the identified text as either indicating malware or not indicating malware;
determining if one of the one or more additional classifiers more accurately classified the identified text as indicating malware or not indicating malware; and
changing to using the additional classifier rather than the classifier to classify the identified as either indicating malware or not indicating malware in response to determining that the additional classifier more accurately classifies the identified text as indicating malware or not indicating malware.

8. The method as recited in claim 1, the notification of the identified text comprising the input data from which the identified text was identified.

9. The method as recited in claim 1, further comprising:
receiving quantitative data describing device usage or security threat encounters;
generating, based on the quantitative data, a quantitative data description;
communicating the quantitative data description to the output module; and
communicating a notification of the quantitative data description to the one or more recipient devices.

10. A system comprising:
an input data collection module configured to obtain multiple pieces of input data each from one of multiple qualitative data sources;
an input data processing module configured to extract text from each piece of input data;
a qualitative data analysis module implementing a classifier configured to classify, for each piece of input data, the piece of input data as malware in response to the extracted text having characteristics of malware; and
an output module configured to send a notification identifying the piece of input data as malware.

11. The system as recited in claim 10, the classifier comprising a binary classifier that classifies the extracted text as either indicating malware or not indicating malware.

12. The system as recited in claim 10, one of the multiple pieces of data comprising an HTML Web page, and the input data processing module being configured to extract text from the HTML Web page by scraping the HTML Web page.

13. The system as recited in claim 10, the multiple qualitative data sources including one or more social media services accessed via the Internet and one or more electronic commerce services accessed via the internet.

14. The system as recited in claim 10, the notification of the identified text comprising the piece of input data from which the identified text was identified.

15. A system implemented on one or more computing devices, the system including:
one or more processors;
one or more computer-readable storage medium having stored thereon multiple instructions that, responsive to execution by the one or more processors, cause the one or more processors to perform acts comprising:
obtaining multiple pieces of input data from one or more qualitative data sources;
identifying text included in each piece of input data;
classifying, using a trained classifier, the identified text as either indicating malware or not indicating malware;
communicating to an output module, for identified text classified as indicating malware, an indication that the piece of input data from which the text was identified is classified as malware; and
communicating a notification of the identified text to one or more recipient devices.

16. The system as recited in claim 15, the one or more qualitative data sources including one or more social media services accessed via the Internet.

17. The system as recited in claim 15, the one or more qualitative data sources including one or more electronic commerce services accessed via the Internet.

18. The system as recited in claim 15, the trained classifier comprising a classifier trained using training data, and the acts further comprising re-training the classifier over time using identified text that is classified as not indicating malware.

19. The system as recited in claim 15, the notification of the identified text comprising the input data from which the identified text was identified.

20. The system as recited in claim 15, the acts further comprising:
receiving quantitative data describing device usage or security threat encounters;
generating, based on the quantitative data, a quantitative data description;
communicating the quantitative data description to the output module; and
communicating a notification of the quantitative data description to the one or more recipient devices.
